(19) United States
(12) Patent Application Publication
(10) Pub. No.: US 2014/0007901 A1
(43) Pub. Date: Jan. 9, 2014

(54) METHODS AND APPARATUS FOR BEVEL EDGE CLEANING IN A PLASMA PROCESSING SYSTEM

(71) Applicants: Jack Chen, San Francisco, CA (US); Gregory Sexton, Fremont, CA (US); Yunsang Kim, Monte Sereno, CA (US)

(72) Inventors: Jack Chen, San Francisco, CA (US); Gregory Sexton, Fremont, CA (US); Yunsang Kim, Monte Sereno, CA (US)

(21) Appl. No.: 13/543,028

(22) Filed: Jul. 6, 2012

(51) Int. Cl. B08B 7/00; B32B 1/04

(52) U.S. Cl. 134/1.1; 428/66.6

(57) ABSTRACT

Methods and apparatus for more efficiently cleaning a substrate having a notch in a plasma processing chamber configured for bevel edge cleaning. A notched plasma exclusion ring an inner periphery and an outer periphery is provided. The notched plasma exclusion ring has a ring notch formed at its outer periphery. The notched plasma exclusion ring has a notch apex dimension that is at least as large as a notch apex dimension of the substrate notch and a notch opening dimension that is at least as large as a notch opening dimension of the substrate notch. Methods for obtaining misalignment data and for subsequently rotate substrates to more efficiently clean the substrate notch are also disclosed.

### BACKGROUND OF THE INVENTION

Plasma-enhanced processing has long been employed to process substrates (e.g., wafers or flat panels) to produce electronic devices (e.g., integrated circuits or flat panel displays). In plasma-enhanced processing, plasma is typically formed from a process gas in order to deposit materials on or etch (remove) materials from the substrate surface. Plasma-enhanced processing may employ a variety of plasma-producing technologies to produce plasma from the supplied source gas(es). Inductively coupled plasma, capacitively coupled plasma, ECR (electro-cyclotron resonance) plasma, etc., are among the more popular technologies employed to generate plasma for processing substrates.

Generally speaking, the substrate may be thought of as a planar structure having an interior planar surface on which device features may be formed. A substrate may have a bevel (sloped) edge around the periphery of the substrate. An example substrate 102 is shown in FIG. 1, including device-forming region 104 and bevel edge 106. Although devices are not formed around the vicinity of the bevel edge, it is important to keep the level of contaminants in the vicinity of the substrate bevel edge low to avoid affecting device yield.

In some cases, certain recipes may call for the bevel edge to be cleaned at various points in time while the substrate is processed. For example, in between certain etching or deposition steps, a bevel edge clean step may be specified by the process recipe.

In some situations, the bevel edge of the substrate may be cleaned using plasma to remove, for example, unwanted polymer deposition. If plasma is employed to clean the bevel edge, the device-forming area of the substrate (i.e., the interior planar surface of the substrate) may be shielded from the bevel edge cleaning plasma such that a donut-shaped cloud of bevel edge cleaning plasma exists in the vicinity of the substrate periphery (i.e., the bevel edge) to perform the bevel edge cleaning task without damaging the device-forming area of the substrate.

Different approaches exist for protecting the device-forming area of the substrate from being damaged due to exposure to the bevel edge cleaning plasma. In a capacitively-coupled plasma chamber, for example, the gap between the upper surface of the substrate and the lower surface of the top electrode may be reduced such that the gap is insufficient to sustain a plasma in the interior, device-forming area of the substrate surface. The gap narrowing may be performed by moving one or both of the lower electrode (on which the substrate is supported) and the upper electrode, for example.

FIG. 2 shows an example of a capacitively coupled plasma chamber 202 that has been equipped for in-situ substrate bevel edge clean. In the example of FIG. 2, an upper electrode 204 and a lower electrode 206 define the upper and lower bounds of a substrate-periphery plasma forming region 246. RF excitation of chuck 208 (via RF power supply 210) generates a plasma in substrate-periphery plasma forming region 246.

Gap 220 between the lower surface of center ceramic component 222 and the upper surface of substrate 224 is kept small such that plasma cannot be sustained in gap 220.

An upper plasma exclusion ring 230 and lower plasma exclusion ring 234 work cooperatively to keep the gap small in the area where plasma is undesired (such as areas over device-forming region 240 on the upper surface of substrate 224.

During plasma-enhanced bevel cleaning, the inner diameter 242 of upper plasma exclusion ring 230 limits the extent of plasma penetration toward device-forming region 240 from plasma in substrate-periphery plasma forming region 246 such that device-forming region 240 disposed in the top surface layer(s) of substrate 224 is protected. Similarly, the inner diameter 244 of lower plasma exclusion ring 234 limits the extent of plasma penetration into the interior region of the backside of substrate 224 such that the backside of substrate 224 is also protected from the bevel edge cleaning plasma.

It is known that a substrate may be provided with one or more notches (typically at least one) in order to assist in orienting the substrate in the chamber. With reference to FIG. 1, for example, substrate 102 may represent a 300 mm round substrate, with the notch disposed at the substrate periphery at position 108 in the figure. An example notch may be about 1 mm deep measured from the bevel edge apex (the outermost periphery of the substrate) to the notch apex (the furthest penetration into the interior region of the substrate by the notch). An example notch may also be about 1 degree in width. Since the notch extends further into the device-forming area of the substrate and away from the periphery, the notch area and particularly the area around the notch apex region may be, in some cases, less exposed to the donut-shaped plasma cloud that is generated for bevel edge cleaning purpose. As such, the notch region may be inadequately cleaned, leading to possible contamination of the devices and lower yield.

he instant application discloses various apparatus and methods for improving bevel edge cleaning of the substrate, including the notch region of the substrate.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows an example substrate, including a device-forming region and a bevel edge.

FIG. 2 shows an example of a capacitively coupled plasma chamber that has been equipped for in-situ substrate bevel edge clean.

FIG. 3 shows, in accordance with an embodiment of the invention, a notched plasma exclusion ring.

FIG. 4 shows, in accordance with an embodiment of the invention, a method for rotationally aligning the substrate with the notched plasma exclusion ring.

FIG. 5 illustrates an implementation of the rotational alignment method using the linear scan approach

FIG. 6 shows, in accordance with an embodiment of the invention, a top-down view of the substrate showing conceptually the circles along which measurement points may be taken.

FIG. 7 shows, in accordance with an embodiment of the invention, the data curves obtained along the measurement points of FIG. 6.

FIGS. 8 and 9 show, in accordance with an embodiment of the invention, a technique for deriving the misalignment offset.

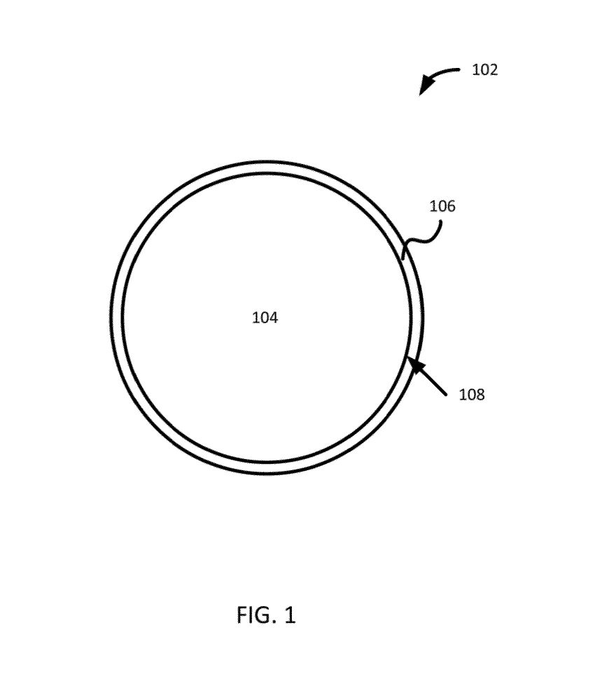

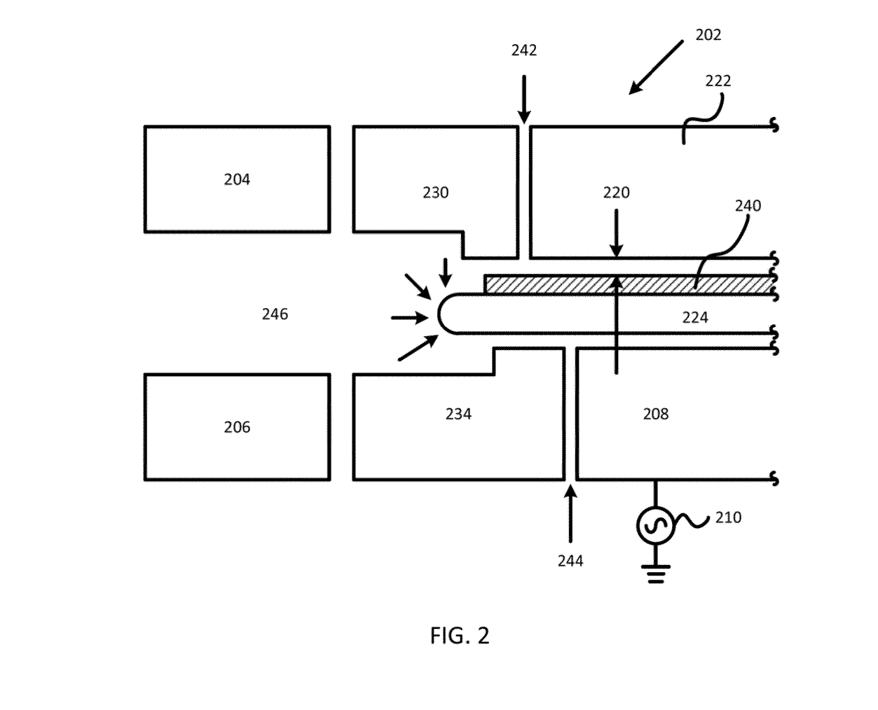

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various

Embodiments of the invention relate to methods and apparatus for improved cleaning of the bevel edge of a substrate, particularly in the notch region of the substrate. In one or more embodiments, at least one notched plasma exclusion ring is provided. The notched plasma exclusion ring may be formed of a ceramic material such as alumina (AL2O3) or a similarly suitable material. Yttrium oxide may be used as a coating in one or more embodiments. A notch is formed in the, outer periphery of the notched plasma exclusion ring.

Generally speaking, the notch created in the notched plasma exclusion ring periphery has approximately the size and shape of the notch in the substrate. Thus, in an embodiment, the notch in the notched plasma exclusion ring may be slightly larger (in the radial—that is along a radius—and/or angular dimension) than the notch in the substrate. In an embodiment, the notch in the notched plasma exclusion ring may be slightly smaller (in the radial and/or angular dimension) than the notch in the substrate. In an embodiment, the notch in the notched plasma exclusion ring may be approximately equal (in the radial and/or angular dimension) to the notch in the substrate. The exact dimension of the notch depends on the efficacy of the cleaning plasma and the specifics of the chamber geometry. In general, the notch should be sufficiently large to ensure (via metrology studies after substrate bevel edge cleaning, for example) acceptable cleaning of the notch region in the substrate while not being unduly large so as to cause damage to the device-forming region of the substrate.

In an embodiment, the notch in the notched plasma exclusion ring may extend through the thickness of the notched plasma exclusion ring. In another embodiment, the notch in the notched plasma exclusion ring may extend only partially through (i.e., not completely through) the thickness of the notched plasma exclusion ring. If the notch is extended only partially through the thickness of the lower notched plasma exclusion ring, the notch may be disposed toward the upper side of the chamber in an embodiment. In another embodiment, if the notch is extended only partially through the thickness of the upper notched plasma exclusion ring, the notch may be disposed toward the lower side of the chamber. In this manner, the notch faces the substrate during bevel cleaning.

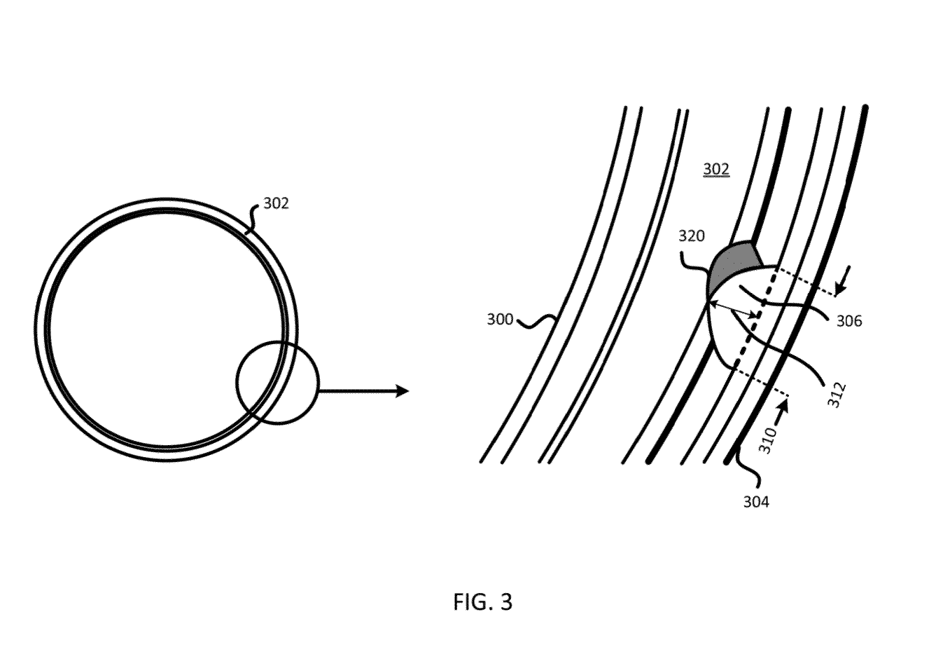

FIG. 3 shows, in accordance with an embodiment of the invention, such a notched plasma exclusion ring. As can be seen in FIG. 3, notched plasma exclusion ring 302 includes an inner periphery 300 and an outer periphery 304. In the example of FIG. 3, ring 302 represents the upper notched plasma exclusion ring (i.e., the notched plasma exclusion ring is disposed below the substrate during bevel clean) although the notch may also be formed in the lower plasma exclusion ring (i.e., the notched plasma exclusion ring is disposed below the substrate during bevel clean) or in both the upper and lower plasma exclusion rings. In the example of FIG. 3, notch 306 is formed at its outer periphery and extends only partially through the thickness of the plasma exclusion ring. Accordingly, plasma protection is not compromised for components behind the exclusionary ring since notch 306 does not extend all the way through the thickness of plasma exclusionary ring 304.

However, the presence of notch 306 permits more of the reactive and neutral species of the bevel cleaning plasma to extend toward the interior region of the substrate, i.e., toward the notch apex 320. Notch opening dimension 310 in ring 302 has a dimension that is configured to enable the bevel cleaning plasma to satisfactorily clean the entire notch opening width of the notch in the substrate. Likewise, notch apex dimension 312 in ring 302 has a dimension that is configured to enable the bevel cleaning plasma to satisfactorily clean the notch, including the apex 320 of the notch in the substrate. In an embodiment, the ring notch apex dimension is at least as large as the notch apex dimension of the substrate. In an embodiment, the ring notch opening dimension is at least as large as the notch opening dimension of the substrate.

In an embodiment, the notched plasma exclusion ring is dimensioned such that the radius between the center of the notched plasma exclusion ring and the inner periphery of the ring is smaller than the radius of the substrate. Further, the radius between the center of notched plasma exclusion ring and the outer periphery of the ring is larger than the radius of the substrate.

Notch depth is preferably sufficiently deep such that bevel cleaning plasma formation and/or sustenance is possible in the ring notch but not too deep as to completely punch through the thickness of ring 302 in an embodiment. In another embodiment, however, the notch may be formed completely through the thickness of the plasma exclusion ring if there is no risk of plasma-related damage to components behind the plasma exclusion ring (i.e., components below ring 302 in the perspective drawing of FIG. 3). In an embodiment, a plasma shield may be disposed behind the notch in the plasma exclusion ring or the component behind the plasma exclusion ring may be formed of a material that is relatively immune to plasma exposure, for example.

To ensure that the substrate notch is properly cleaned during bevel etch clean, the notch in the plasma exclusion ring should align with the notch in the substrate. However, the provision of a notch in the plasma exclusion ring results in an additional dimension, namely the angular dimension, that requires alignment in the manner that did not exist before.

To elaborate, aligning the substrate with the process center of the chamber typically involves the use of the robot arm software to ensure that corrections to X and Y positions are made when the substrate is placed by the robot arm on the substrate support for processing. The correction in the X and Y dimensions aligns the substrate center with the processing center and is typically done using the robot arm in the prior art. The presence of the plasma exclusion ring notch at an angle theta (measured from a predefined reference angle) requires that the substrate be rotated so that the substrate notch is also at the same angle theta from the reference angle when the substrate is placed on the substrate support for processing and/or bevel edge cleaning.

In an embodiment, substrate rotation for angular alignment is performed after X/Y alignment has been completed. In an embodiment, a rotational aligner external to the chamber is employed to rotate the substrate around its center in order to rotationally align the notch angle of the substrate with the notch angle of the plasma exclusion ring in the chamber. The use of a rotational aligner simplifies retrofitting since robot software and/or other chamber hardware may be kept the same.

Once the angular alignment is performed by rotating the substrate such that the notch in the substrate is at the same angle theta as that of the notch in the notched plasma exclusion ring, the robot arm may move the substrate into the chamber and place the substrate on the chuck (and perform any necessary X and Y corrections during the placement) so that once the substrate is positioned by the robot arm on the chuck for processing, dimensions X, Y, and angle theta are properly aligned between the substrate, the chuck, and the plasma exclusion ring, including the notches of the substrate and of the plasma exclusion ring.

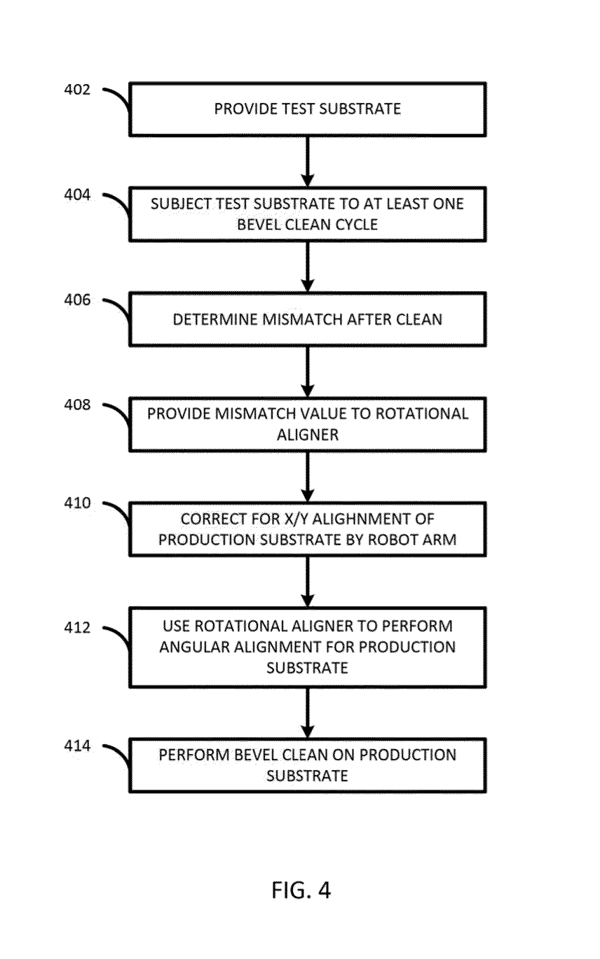

FIG. 4 shows, in accordance with an embodiment of the invention, a method for rotationally aligning the substrate prior to robot arm handling such that both the substrate notch and the plasma exclusion ring notch are at the same angle theta with respect to a reference angle in the chamber during processing and/or plasma bevel edge clean. In an embodiment, a test substrate may be provided (402) and employed for the rotational alignment task.

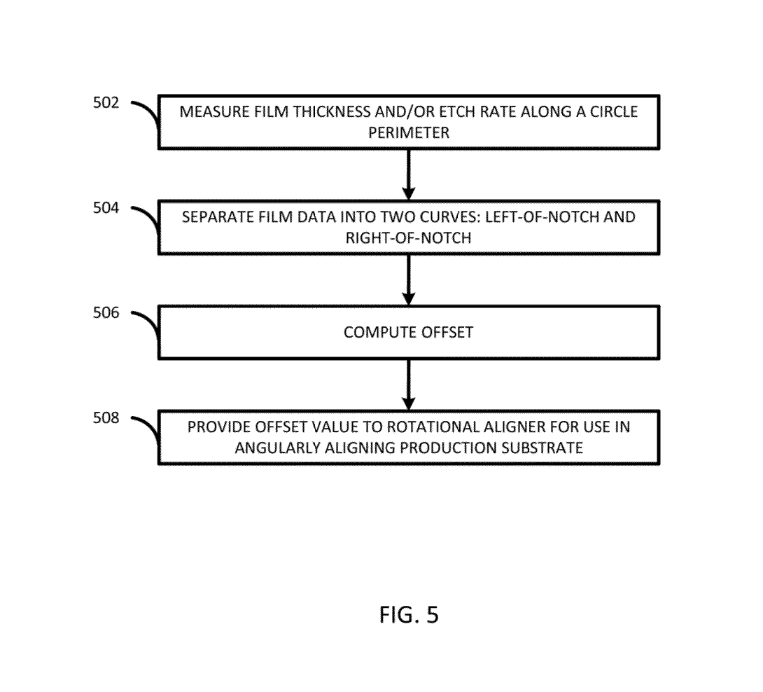

In step 404, the test substrate is placed into the chamber and undergoes at least one bevel clean cycle. In step 406, the test substrate is removed for determining the mismatch, if any, between the substrate notch and the plasma exclusion ring notch. The determination in step 406 may be made using an optical microscope tool or by linearly scanning the test substrate for film thickness data after the test clean cycle has been performed. FIG. 5 illustrates an implementation of the rotational alignment method using the linear scan approach. FIG. 5 will be discussed later herein. The determination of the mismatch between the substrate notch and the plasma exclusion ring notch may be done for each chamber in a multi-chamber cluster tool.

In step 408, data pertaining to the mismatch between the substrate notch and the plasma exclusion ring notch (i.e., the misalignment data) is provided to a rotational aligner. In step 410, the robot arm corrects for X and Y mis-alignment (if needed) before or while performing the task of placing the substrate on the chuck in the plasma chamber for processing. In step 412, the rotational aligner performs rotational correction on the substrate also before or while performing the task of placing the substrate on the chuck in the plasma chamber for processing. Processing may then proceed. In step 414, bevel edge clean is performed when called for by the process recipe.

An optical or electron microscope capable of imaging the wafer edge may be employed to ascertain (step 406 of FIG. 4) the mismatch in alignment between the test substrate notch and the plasma exclusion ring notch after the test substrate is processed in step 404 of FIG. 4. However, it is recognized by the inventors herein that not all semiconductor processing facilities would have ready access to such microscopes. It is realized, however, that most, if not all, semiconductor processing facilities tend to employ thin film measurement tools such as ASET-F5X™, available from KLA-Tencor of Milpitas, Calif. or other thin-film metrology tools capable of measuring film thickness. In accordance with embodiments of the invention, methods are developed for using existing thin-film measurement tools to obtain the misalignment data discussed in connection with step 406 of FIG. 4.

FIG. 5 shows, in accordance with an embodiment of the invention, the steps for obtain the misalignment data (called for in step 406 of FIG. 4) for angular correction purposes. The steps of FIG. 5 may be performed using a computer-implemented method, for example. In step 502, the substrate is measured for film thickness along at least one circle perimeter on the substrate, which circle is centered on the substrate center, that intersects the zone of film thickness variation caused by the notch in the plasma exclusion ring. As the term is employed herein, the zone of film thickness variation represents the substrate region in the vicinity of the substrate that is affected, in terms of film thickness or etch rate, by the presence of the notch in the plasma exclusion ring. In an embodiment, the circle intersects the substrate notch (i.e., has a radius that is larger than the distance between the notch apex and the substrate center).

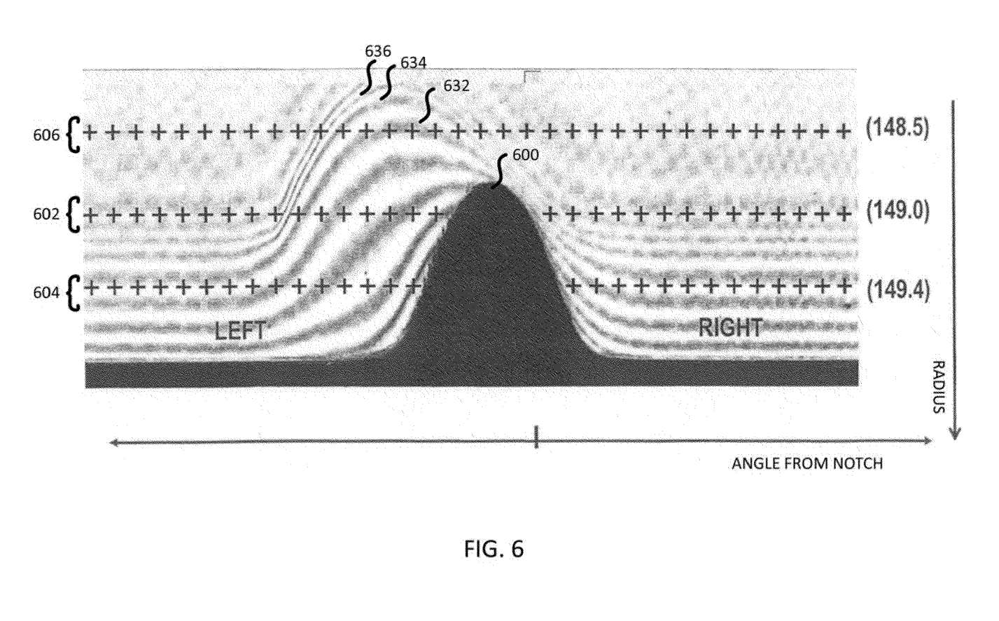

FIG. 6 is a top-down view of the substrate showing conceptually the circles along which measurement points may be taken. In the example of FIG. 6, the circle perimeters 602 and 604 having the radii of 149.0 mm and 149.4 mm represent circles that intersect the notch 600. On the other hand, the circle perimeter 606 having the radius of 148.5 does not intersect the notch but is still within the zone of film thickness variation (shown by profile lines 632, 634, 636) caused by the presence of the notch on the plasma exclusion ring. Preferably the measurements are made at measuring points slightly to the left and to the right of the notch 600 along the circle perimeter.

Returning now to FIG. 5, in step 504, the etch rate profile or film thickness profile (“film data”) is then separated into two curves: one to the left of the notch (“left-of-notch curve”) and one to the right of the notch (“right-of-notch curve”). Conceptually speaking, this may be thought of as separating the metrology data into two different sets of data points, one representing data points obtained to the left side of the radius that connects the center of the ring to the ring notch apex, and one representing data points obtained to the right side of the radius that connects the center of the ring to the ring notch apex

In step 506, the best offset is computed, using mathematical techniques to minimize the difference between first data set and the second data set, or the difference between the left-of-notch curve and the right-of-notch curve. The offset that can best minimize the difference represents the misalignment data to be employed for rotating production substrate in order to angularly align the substrate notch with the notch in the plasma exclusion ring (508). In one or more embodiments, weighting parameters may be employed to optimize centering.

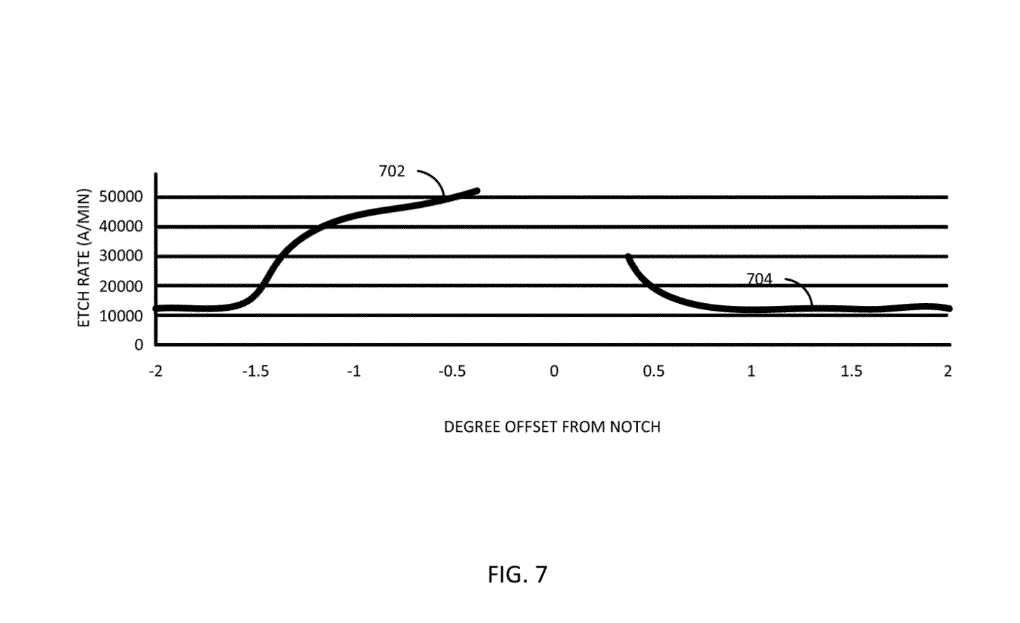

In the example of FIG. 6, film thickness or film etch rate is measured at various measuring points (marked by the symbol “+”) along three different radiuses (148.5 mm, 149 mm, 149.4 mm) although measurements along only one circle perimeter would suffice in many cases. The etch rate measurement data for the circle 602 having a radius of 149 mm (see FIG. 6) is shown in FIG. 7 and employed for calculating the misalignment parameter. Curve 702 represents the left-of-notch curve, and curve 704 represents the right-of-notch curve.

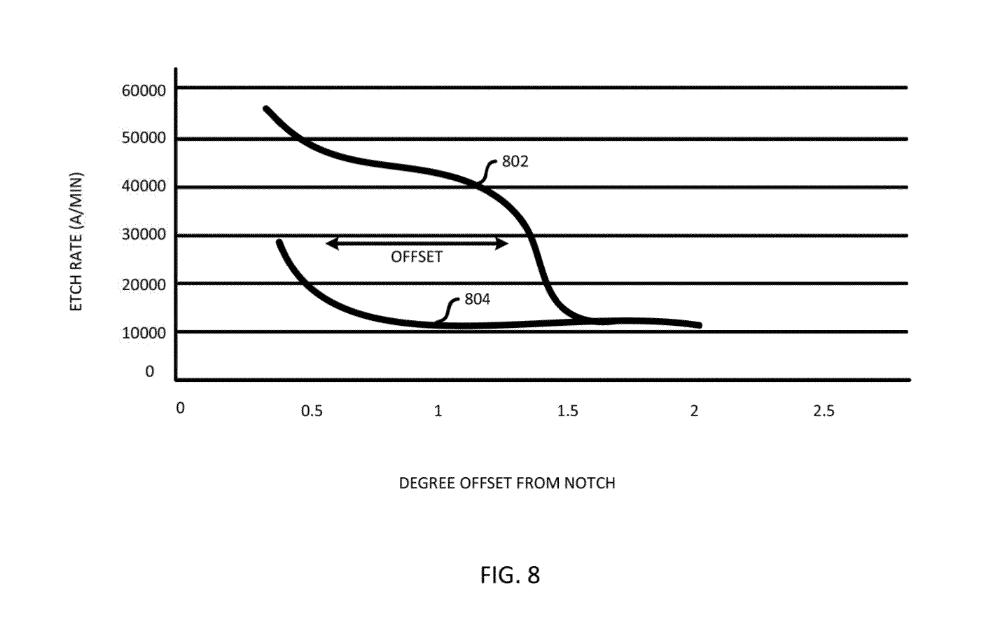

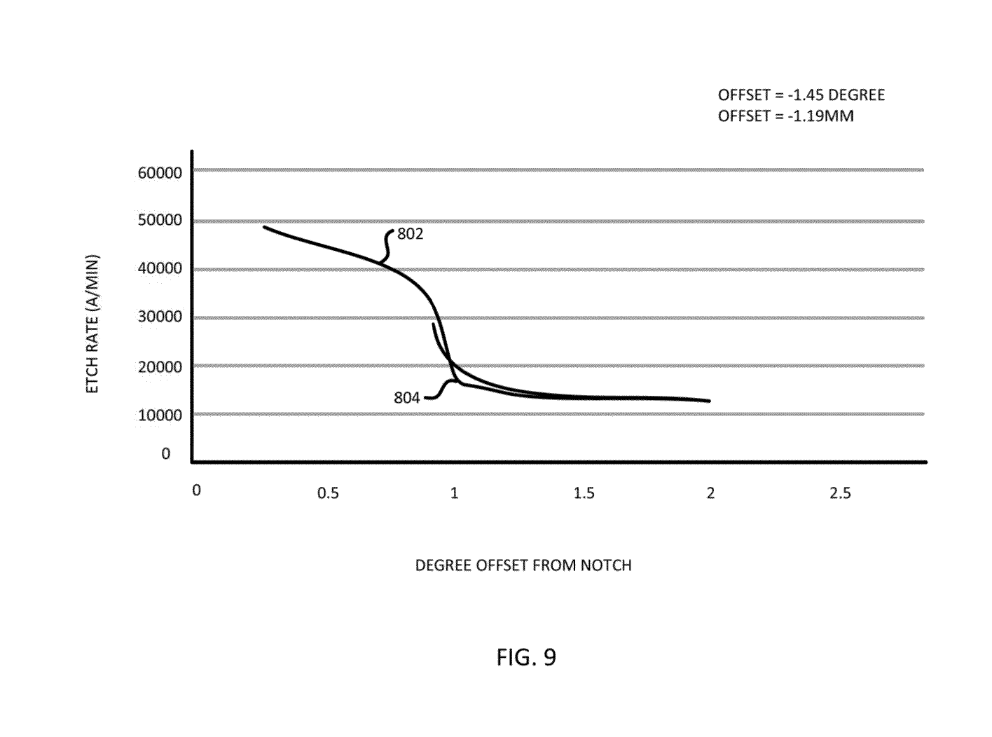

FIG. 8 shows an example technique for deriving the misalignment data from the left-of-notch curve 702 (e.g., etch rate or film thickness to the left of the test substrate notch) and right-of-notch curve 704 (e.g., etch rate or film thickness to the right of the substrate notch). In FIG. 8, the left-of-notch curve 802 is a vertically flipped mirror image of left-of-notch curve 702. Left of notch curve 802 and right-of-notch curve 804 are then brought together (such as by translating one of the two sets of data points toward the other) to minimize their difference (FIG. 9). In the example of FIG. 8, the misalignment is determined to be 0.45 degree or 1.19 mm. This misalignment is then employed for rotational correction for the production substrates. Although FIG. 9 is an example technique, other techniques exist for finding the value that minimizes the difference between the left-of-notch curve data and the right-of-notch curve data in order to derive the misalignment data for angular correction purposes.

In accordance with an embodiment of the invention, it is also determined that bevel cleaning is more thorough in the notch region if the RF frequency employed to generate the bevel cleaning plasma at a lower frequency instead of the usual higher frequency, such as about 13 MHz. It has been found that when 2 MHz is employed for generating the bevel cleaning plasma, notch cleaning is effective even in the absence of the notch in the plasma exclusion ring. Under certain condition with the lower frequency plasma, it has been observed visually that the plasma glow is more intense inside the notch than elsewhere around the wafer. This is due to the lower RF frequency allows the DC bias of the wafer to be driven more negative than higher RF frequency and allows for formation of a hollow cathode that generates more reactive species inside notch. This may be desirable as the notch cleaning is self aligned to the notch and will not require additional alignment. However, it is also possible (and even desirable in some cases) to perform bevel/notch cleaning using the 2 MHz frequency for generating the bevel edge cleaning plasma in conjunction with the use of a notch in the plasma exclusion ring.

As can be appreciated from the foregoing, embodiments of the invention enable the notch region of the substrate to be properly cleaned during plasma-enhanced bevel clean. The notch formed in the plasma exclusion ring, either partially or completely through the plasma exclusion ring thickness, represents a simple and effective method to ensure proper notch cleaning. Methods are disclosed to leverage on existing thin film metrology tools to derive the needed angular alignment data to rotationally align the substrate notch with the notch in the notched plasma exclusion ring in order to optimize notch cleaning.

While this invention has been described in terms of several preferred embodiments, there are alterations, permutations, and equivalents, which fall within the scope of this invention. Although various examples are provided herein, it is intended that these examples be illustrative and not limiting with respect to the invention. For example, although the figures are discussed in connection with a capactively coupled plasma chamber, the invention may also be applied to chamber that generates plasma using other plasma generation technologies such as Inductively coupled plasma, ECR (electro-cyclotron resonance) plasma, microwave, etc.

Also, the title and summary are provided herein for convenience and should not be used to construe the scope of the claims herein. Further, the abstract is written in a highly abbreviated form and is provided herein for convenience and thus should not be employed to construe or limit the overall invention, which is expressed in the claims. If the term “set” is employed herein, such term is intended to have its commonly understood mathematical meaning to cover zero, one, or more than one member. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A notched plasma exclusion ring for use in a plasma processing chamber, said plasma processing chamber is configured for plasma-enhanced bevel cleaning of a substrate, said substrate having a substrate notch, comprising:
a ceramic ring having an inner periphery and an outer periphery, said ceramic ring having a ceramic ring notch formed at its outer periphery, said ceramic ring notch having a notch apex dimension that is at least as large as a notch apex dimension of said substrate notch and a notch opening dimension that is at least as large as a notch opening dimension of said substrate notch.

2. The notched plasma exclusion ring of claim I wherein said ceramic ring notch extends completely through a thickness of said ceramic ring.

3. The notched plasma exclusion ring of claim 1 wherein said ceramic ring notch extends only partially through a thickness of said ceramic ring.

4. The notched plasma exclusion ring of claim 1 wherein said ceramic ring includes Al2O3.

5. The notched plasma exclusion ring of claim I wherein said ceramic ring includes an yttrium oxide coating.

6. The notched plasma exclusion ring of claim I wherein said ceramic ring is disposed above said substrate during said plasma-enhanced bevel cleaning.

7. The notched plasma exclusion ring of claim 1 wherein said ceramic ring is disposed below said substrate during said plasma-enhanced bevel cleaning.

8. The notched plasma exclusion ring of claim 1 wherein said notch apex dimension of said ceramic ring is larger than said notch apex dimension of said substrate.

9. The notched plasma exclusion ring of claim I wherein said notch depth dimension of said ceramic ring is larger than said notch depth dimension of said substrate.

10. The notched plasma exclusion ring of claim 1 wherein a first radius between a center of said ceramic ring and said inner periphery is smaller than a radius of said substrate, and wherein a second radius between said center of said ceramic ring and said outer periphery is larger than said radius of said substrate.

11. A method for processing a substrate in a plasma processing chamber, said plasma processing chamber configured for plasma-enhanced bevel cleaning of a substrate having a substrate notch, said plasma processing chamber having a notched plasma exclusion ring having a ring notch, comprising:
obtaining misalignment data between said substrate notch and said ring notch, said misalignment data pertaining to rotational correction performed when placing said substrate on a chuck in said plasma processing chamber;
performing X/Y correction to positioning of said substrate prior to placing said substrate on said chuck;
performing said rotational correction, using said misalignment data, to said substrate after said performing said X/Y correction;
placing said substrate on said chuck after said performing said X/Y correction and said performing said rotational correction is completed; and
performing said plasma-enhanced bevel cleaning after said substrate is placed on said chuck.

12. The method of claim 11 wherein said misalignment data is obtained previously using a test substrate other than said substrate.

13. The method of claim 11 wherein said plasma-enhanced bevel cleaning employs an RF signal having an RF frequency of about 2 MHz.

14. The method of claim 11 wherein said ring notch extends completely through a thickness of said ceramic ring.

15. The method of claim 1 I wherein said ring notch extends only partially through a thickness of said notched plasma exclusion ring.

16. The method of claim II wherein said ceramic ring includes Al2O3.

17. A method for processing a substrate in a plasma processing chamber, said plasma processing chamber configured for plasma-enhanced bevel cleaning of substrates each having at least one substrate notch, said plasma processing chamber having a notched plasma exclusion ring having a ring notch, comprising:
providing a first substrate;
disposing said first substrate on a chuck in said plasma processing chamber;
performing said plasma-enhanced bevel cleaning on said first substrate; and
obtaining misalignment data between said substrate notch and said ring notch from metrology data obtained from said substrate after said performing said plasma-enhanced bevel cleaning on said first substrate, said misalignment data pertaining to rotational correction performed on a second substrate subsequently undergoing said plasma-enhanced bevel cleaning in said plasma processing chamber in order to more efficiently clean a substrate notch in said second substrate.

18. The method of claim 17 wherein said obtaining said misalignment data includes:
obtaining a plurality of film thickness data points by measuring film thickness alone at least one circle perimeter on said substrate;
separating said plurality of film thickness data points into at least a first set of data points and a second set of data points, said first set of data points representing data points measured along said circle perimeter on a first side of a radius between a center of said substrate and an apex of said substrate notch, said second set of data points representing data points measured along said circle perimeter on a second side of said radius between said center of said substrate and said apex of said substrate notch, said second side being opposite said first side;
computing a value that minimizes a difference between said first set of data points and said second set of data points; and
designating said value said misalignment data.

19. The method of claim 17 wherein said computing said value includes minimizing a difference between a curve representing said first set of data points and a curve representing said second set of data points.

20. The method of claim 17 wherein said computing said value includes:
determining a value to translate said first set of data point toward said second set of data point along said circle perimeter such that said difference between said first set of data points and said second set of data points is minimized; and
designating said value said misalignment data.

21. The method of claim 17 wherein said notched plasma exclusion ring is disposed above said first substrate during said plasma-enhanced bevel cleaning.

22. The method of claim 17 wherein said notched plasma exclusion ring is disposed below said first substrate during said plasma-enhanced bevel cleaning.
